(19) United States
(12) Patent Application Publication
(10) Pub. No.: US 2011/0027007 A1
(43) Pub. Date: Feb. 3, 2011

(54) Retrofittable cable mechanical fuse

(76) Inventors: David Tunno, Valley Springs, CA (US); Stuart Larsen, Ventura, CA (US)

Correspondence Address: JAMES E. BRUNTON, ESQ., P. O. BOX 29000, GLENDALE, CA, 91209, US

(21) Appl. No.: 12/924,838

(22) Filed: Oct. 5, 2010

Related U.S. Application Data
(63) Continuation-in-part of application No. 11/949,753, filed on Dec. 3, 2007.

(51) Int. Cl. F16G 11/12

(52) U.S. Cl. 403/2

(57) ABSTRACT

A mechanical fuse device having a weakened central portion and end portions that clamp to a cable having a slack portion located between the end portions. The device bends or breaks at the weakened central portion at loads less than the breaking load of the cable. The bending of the weakened central portion of the device provides measurable data relevant to the loads experienced by the cable.

### CROSS-REFERENCE TO RELATED APPLICATIONS

This is a Continuation-in-Part of co-pending U.S. application Ser. No. 11/949,753 filed Dec. 10, 2007.

### STATEMENT REGARDING FEDERALLY SPONSORED RESEARCH OR DEVELOPMENT: Not Applicable

### INCORPORATION-BY-REFERENCE OF MATERIAL SUBMITTED ON A COMPACT DISC: Not Applicable

### BACKGROUND OF THE INVENTION

1. Field of the Invention

This invention relates generally to mechanical fuses for cordage and cable in particular. These fuses are fitted to cable and are designed to fail at a specified load less than the rated load of the cable. In so doing, the fuse indicates to the user that the cable may have experienced a stress load level requiring it to be replaced.

2. Description of Related Art Including Information Disclosed Under 37 CFR 1.97 and 1.98

There are no known prior art examples of mechanical fuses for cable that are retrofittable, that is, able to be fitted to the cable in the field without the need to remove existing end fittings and/or cut the cable.

There are, however, a number of mechanical fuse patents for cable. They include the U.S. Pat. No. 5,466,082 patent to Sherar, the U.S. Pat. No. 5,400,868 patent to Ellis, the U.S. Pat. No. 4,992,778 patent to McKeen and the U.S. Pat. No. 7,424,996 patent to Larsen. None of the aforementioned patents teach a retrofittable device as that term is used in the present application and all of these patents are markedly different from the present invention in many other respects.

The Thompson U.S. Pat. No. 3,910,224 patent is retrofittable, but is a device designed to provide pre-failure warning of cyclical stress due to vibration, not a fuse as that term is used in the present application. The '224 patent is also markedly different from the present invention in many other respects.

The Laws U.S. Pat. No. 3,436,962 patent is retrofittable but it is a tension sensor, not a fuse as that term is used in the present application. The '962 patent is also markedly different from the present invention in many other respects.

Also disclosed is the Ibanez U.S. Pat. No. 4,791,243 patent. It is not retrofittable to a cable. It also does not include a fuse component as that term is used in the present invention.

### BRIEF SUMMARY OF THE INVENTION

Objectives of the present invention include the following:

1. To provide a retrofittable cable fuse that may be installed in the field without removal of the end fittings and without cutting the cable.

2. To provide a retrofittable cable fuse that deforms and/or fails (breaks or trips) at a pre-determined load (e.g. tensile force, bending force, or a combination thereof) less than the maximum rated tension of the cable.

3. To provide a retrofittable cable fuse that deforms measurably and which measurement can be correlated to loads experienced by the cable.

4. To provide a retrofittable cable fuse that is of simple design.

5. To provide a retrofittable cable fuse that is economical to manufacture.

By way of brief summary, in accordance with the present invention, a mechanical fuse is provided that clamps at two locations to a cable with a slack portion between the clamped positions and bends or breaks at a weakened area on the fuse at tension loads less than the maximum rated load of the cable.

### BRIEF DESCRIPTION OF SEVERAL VIEWS OF THE DRAWINGS

FIG. 1 is a perspective view of the asymmetric 3-sided “U” shaped retrofittable wire rope fuse attached to a wire rope with clamping end plates.

FIG. 2 is an exploded perspective view of the asymmetric 3-sided “U” shaped retrofittable wire rope fuse shown in FIG. 1.

FIG. 3 is a planar view of the asymmetric 3-sided “U” shaped retrofittable wire rope fuse body showing the fuse body deformation due to loading less than the predetermined maximum load limit.

FIG. 4 is a perspective view of the asymmetric 3-sided “U” shaped retrofittable wire rope fuse attached to a wire rope with clamping end plates that has tripped or failed due to a wire rope tensile load greater than the predetermined maximum load limit.

### DETAILED DESCRIPTION OF THE INVENTION

By way of brief introduction, the primary function of the apparatus of the present invention is to provide a visible indicator that a wire rope installation has been overloaded.

A secondary function of the apparatus of the invention is to provide a convenient method to measure the current load being supported by a wire rope installation using a linear caliper.

Distinct from the prior art wire rope mechanical fuses, the present invention can be retrofitted to a wire rope installation in the field without the need to remove end fittings and/or cut the wire rope. No modification or additional structural items need be added to the existing wire installation. The retrofittable wire rope fuse can be installed on any section of wire rope installation using ordinary hand tools. It is also much simpler and more economical to both manufacture and install.

The main body of the retrofittable fuse is an asymmetric generally “U” shaped structure. One vertical leg of the structure is clamped to the wire rope at a convenient location. The load in the wire rope installation is relieved and the remaining vertical leg of the “U” shaped structure is clamped to the wire rope with a small amount of slack left in the wire rope between the two vertical legs of the structure. The load in the wire rope installation is then returned to the designed limits. The slackened section of the wire rope between the two leg sections of the “U” shaped structure supports no load since the load is transferred from the wire rope into the fuse body. The center section of the structure is very sensitive to the bending movement applied by the offset axial load from the wire rope. This deformation takes the shape of a circular arc the depth of which is easily measured with a conventional linear caliper. The secondary function of the apparatus of the invention is achieved by measuring the magnitude of this deformed center section of the “U” shaped body and comparing it to tabulated data of deformation versus wire rope axial load.

The center section of this “U” shaped body is provided with notches that are machined in the top and bottom surfaces resulting in a weaken section due not only to the reduced area but also due to the presence of stress concentrations. This section is designed to fail at a predetermined wire rope axial load. When this predetermined wire rope load is exceeded the fuse fails, transferring the wire rope load back into the previous slackened section of the wire rope between the two legs of the “U” shaped fuse body. The primary function of the apparatus of the present invention is achieved when the center section of the “U” shaped body breaks, providing a clear visible indicator that the wire rope installation has been overloaded.

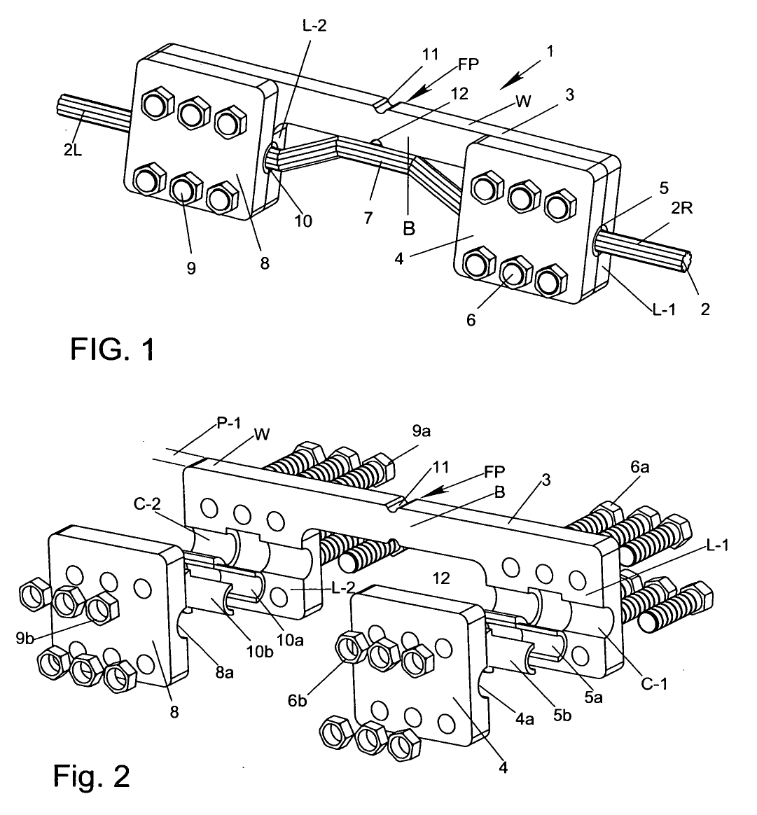

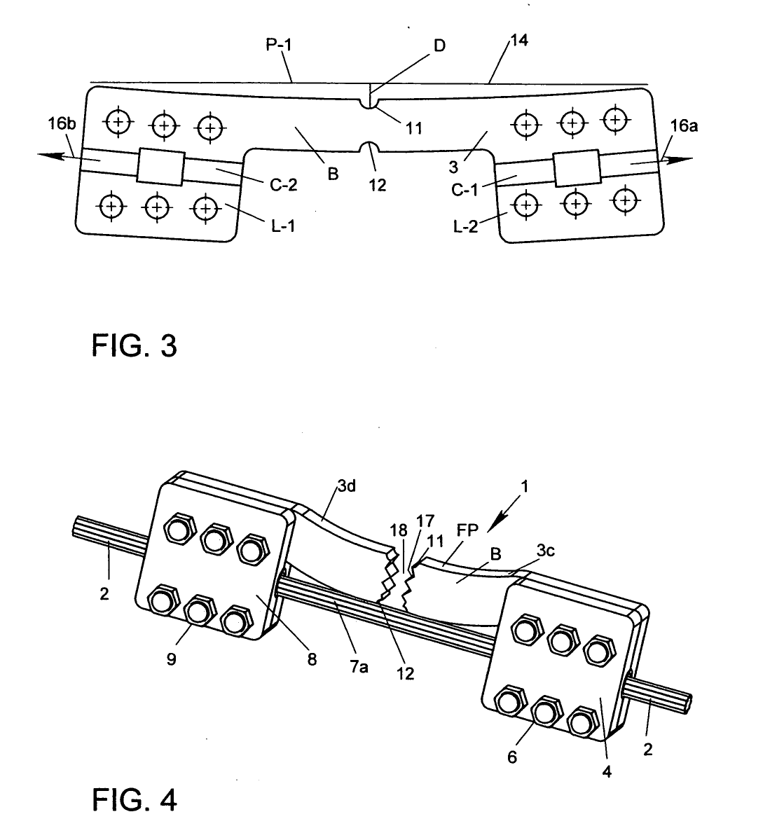

Referring now to the drawings and particularly to FIGS. 1 and 2, one form of the apparatus of the invention for interconnection with the wire rope to provide a visible indication that the wire rope has been overloaded, is there shown and generally designated by the numeral 1. In this form of the invention, the apparatus comprises an asymmetric fuse body here shown as a generally “U” shaped body 3 having a first leg L-1, a second leg L-2, and a breakable bite portion B having a central frangible portion FP. As indicated in the drawings, first and second legs L-1 and L-2 extend substantially perpendicularly to the bite portion B. Frangible portion FP, which includes a top wall W disposed in a first plane P-1, is deformable from a first position shown in FIGS. 1 and 2 to a second position shown in FIG. 3 wherein the central, frangible portion is spaced apart from the first plane by a visible, measurable distance D. Bite portion B is further deformable from the second position to a third position shown in FIG. 4 of the drawings, wherein the bite portion is broken.

A first end plate 4 is connected to the first leg L-1 of the “U” shaped body using a plurality of fasteners 6 and cooperates therewith to form a first wire rope gripping channel C-1. Similarly, a second end plate 8 is connected to the second leg L-2 of the “U” shaped body using a plurality of fasteners 9 and cooperates therewith to form a second wire rope gripping channel C-2. Disposed within channel C-1 is a malleable insert 5 and disposed within channel C-2 is a malleable insert 10. The purpose of these malleable inserts will presently be described. As illustrated in FIGS. 1 and 2 of the drawings, the central frangible portion FP of the bite portion B comprises a pair of opposing notches formed in the bite portion. More particularly, the central frangible portion FP here comprises an upper notch 11 and a lower notch 12.

In using the apparatus of the invention, the “U” shaped body 3 is clamped onto the wire rope end 2R by end plate 4 using the bolt and nut pattern 6. The clamping force created by the bolt and nut pattern 6 deforms the malleable insert 5 into the strands of the wire rope 2 to secure the right end of the body 3 onto the wire rope 2. Slack or curvature 7 is imposed on the wire rope 2 before end plate 8 is clamped onto the wire rope end 2L using the bolt and nut pattern 9. Again, the clamping force created by the bolt and nut pattern 9 deforms a malleable insert 10 into the strands of the wire rope 2 to secure the left end of fuse body 3 onto the wire rope 2.

As a tensile load is applied to wire rope 2, the load in the wire rope section 2R is diverted from the wire rope section 2R by the clamped section 4 into the mid-section of the “U” shaped body. The load is then returned to the wire rope 2 at section 2L by the clamped section 8. The wire rope section 7 supports no load. The notched sections 11 and 12 create a stress concentration causing the section to fail or fracture at this location when the axial and bending loads at this critical section reach a predetermined magnitude. In order to adjust the failure characteristics of the critical section, it may be necessary to heat treat the fuse body or locally work-harden the center section of the fuse body. Such procedures used to adjust material properties are well known and may also be used to create a weakened area apart from the use of a reduced area of material.

The single asymmetric retrofittable wire rope assembly 1 shown in FIG. 1 is exploded in FIG. 2 to illustrate how the assembly is connected or retrofitted to an existing wire rope. The wire rope 2 of FIG. 1 is omitted from FIG. 2 to help clarify the individual components of the fuse assembly.

With reference to FIG. 2, the fuse body 3 has a bolt hole pattern through which bolts 6a and nut 6b clamp end plate 4 onto the “U” shaped body 3. Section C-1 in body 3 accepts the malleable insert 5a restricting the insert 5a from moving longitudinally. The mating end plate 4 includes section 4a to trap and restrict longitudinal motion of malleable insert 5b. As the end plate 4 is clamped onto the body 3 using bolts 6a and nuts 6b, the malleable inserts 5a and 5b are extruded into the wire strands of the wire rope forming a swedged connection securing the wire rope 2 in FIG. 1 to the body 3. Slack is then formed in the wire rope 2 of FIG. 1 and the clamping procedure previously described is repeated to secure the remaining end of the wire rope 2 of FIG. 1.

To create the slack in wire rope 2, the tension in the existing wire rope is relieved as much as necessary and the wire rope assembly 1 is retrofitted to the wire rope 2 as illustrated and described in FIG. 1 and FIG. 2. The wire rope is then re-tensioned to the required designed load.

A planar view of fuse body 3 subjected to a tensile loading is shown in FIG. 3. The applied end loads 16a and 16b cause bending in the fuse body center section resulting in a measurable displacement D. Having measured this displacement D, the tensile load 16a and 16b imposed on the wire rope may be estimated through previous calibration of body 3.

Alternatively, the asymmetric fuse may be constructed without reduced areas 11 and 12 so as only to deform under load, not to trip (break or fail). This embodiment can be constructed so as to continue deforming until the load is transferred to the wire rope.

FIG. 4 shows an asymmetric wire rope fuse assembly 1 of FIG. 1 that has been subjected to an axial load in wire rope 2 greater than the predetermined maximum allowable tensile load. The bite portion B has tripped by fracturing at surface 17 located proximate the reduced areas or notches 11 and 12. The generally “U” shaped body 3 having separated into two parts 3c and 3d, cause the load previously supported by the fuse body to be transferred back into the wire rope section 7a. Wire rope section 7a has been straightened as it supports load. The separation gap 18 between the separated section 3c and 3d of the fuse body represents the amount of slack formed in the wire rope section 7 of FIG. 1 upon installation.

The foregoing has been a description of the preferred embodiments of the present invention. It is understood that those skilled in the art may depart from the descriptions of the preferred embodiments without departing from the scope and spirit of the invention as set forth in the following claims.

1. An apparatus for interconnection with the wire rope to provide a visible indication that the wire rope has been overloaded, said apparatus comprising:
(a) a “U” shaped body having a first leg, a second leg and a breakable bite portion having a central, frangible portion having a top wall disposed in a first plane, said bite portion being deformable from a first position to a second position wherein said central, frangible portion is spaced apart from said first plane by a visible, measurable distance;
(b) a first end plate connected to said first leg of said “U” shaped body and cooperating there with the form a first wire rope gripping channel; and
(c) a second end plate connected to said second leg of said “U” shaped body and cooperating there with the form a second wire rope gripping channel.

2. The apparatus as defined in claim 1 in which said bite portion is further deformable from said second position to a third position wherein said bite portion is broken.

3. The apparatus as defined in claim 1 in which said first and second legs of said “U” shaped body extend substantially perpendicularly to said bite portion.

4. The apparatus as defined in claim 1 in which said first and second end plates are interconnected with said first and second legs of said “U” shaped body by a plurality of threaded fasteners.

5. The apparatus as defined in claim 1, further including a first malleable insert disposed within said first wire gripping channel and a second malleable insert disposed within said second wire gripping channel.

6. The apparatus as defined in claim 1 in which said central frangible portion of said bite portion comprises a notch formed in said bite portion of said “U” shaped body.

7. The apparatus as defined in claim 1 in which said central frangible portion of said bite portion comprises a pair of opposing notches formed in said bite portion of said “U” shaped body.

8. An apparatus for interconnection with the wire rope to provide a visible indication that the wire rope has been overloaded, said apparatus comprising:
(a) a “U” shaped body having a first leg extending substantially perpendicular to said bite portion, a second leg extending substantially perpendicular to said bite portion and a breakable bite portion having a central, frangible portion having a top wall disposed in a first plane, said bite portion being deformable from a first position to a second position wherein said central, frangible portion is spaced apart from said first plane by a visible, measurable distance;
(b) a first end plate connected to said first leg of said “U” shaped body and cooperating there with the form a first wire rope gripping channel;
(c) a second end plate connected to said second leg of said “U” shaped body and cooperating there with the form a second wire rope gripping channel;
(d) a first malleable insert disposed within said first wire gripping channel; and
(e) a second malleable insert disposed within said second wire gripping channel.

9. The apparatus as defined in claim 8 in which said bite portion is further deformable from said second position to a third position wherein said bite portion is broken.

10. The apparatus as defined in claim 8 in which said first and second end plates are interconnected with said first and second legs of said “U” shaped body by a plurality of threaded fasteners.

11. The apparatus as defined in claim 8 in which said central frangible portion of said bite portion comprises a notch formed in said bite portion of said “U” shaped body.

12. The apparatus as defined in claim 8 in which said central frangible portion of said bite portion comprises a pair of opposing notches formed in said bite portion of said “U” shaped body.

13. An apparatus for interconnection with the wire rope to provide a visible indication that the wire rope has been overloaded, said apparatus comprising:
(a) a “U” shaped body having a first leg extending substantially perpendicular to said bite portion, a second leg extending substantially perpendicular to said bite portion and a breakable bite portion having a central, frangible portion having a top wall disposed in a first plane and having a pair of opposing notches, said bite portion being deformable from a first position to a second position wherein said central, frangible portion is spaced apart from said first plane by a visible, measurable distance;
(b) a first end plate connected to said first leg of said “U” shaped body and cooperating there with the form a first wire rope gripping channel;
(c) a second end plate connected to said second leg of said “U” shaped body and cooperating there with the form a second wire rope gripping channel;
(d) a first malleable insert disposed within said first wire gripping channel; and
(e) a second malleable insert disposed within said second wire gripping channel.

14. The apparatus as defined in claim 13 in which said bite portion is further deformable from said second position to a third position wherein said bite portion is broken.

15. The apparatus as defined in claim 13 in which said first and second end plates are interconnected with said first and second legs of said “U” shaped body by a plurality of threaded fasteners.
